(19) United States
(12) Patent Application Publication
(10) Pub. No.: US 2022/0185734 A1
(43) Pub. Date: Jun. 16, 2022

(54) Method for reducing or avoiding alkali-aggregate reaction in set concrete

(71) Applicant: Wacker Chemie AG, Munich (DE)

(72) Inventors: Volker Stanjek, Ampfing (DE); Heinz Geich, Marktl (DE); Peter Jerschow, Burghausen (DE)

(73) Assignee: Wacker Chemie AG, Munich (DE)

(21) Appl. No.: 17/598,748

(22) PCT Filed: Mar. 27, 2019
(86) PCT No.: PCT/EP2019/057790

§ 371 Date: Sep. 27, 2021

(51) Int. Cl. C04B 24/42; C04B 28/02

(52) U.S. Cl. CPC C04B 24/42; C04B 2111/2023; C04B 28/02

(57) ABSTRACT

A method for reducing or avoiding an alkali-aggregate reaction in a cured concrete. The method includes providing a curable concrete mixture which includes alkali-sensitive aggregates (A), at least one organosilicon compound (B) and/or at least one siloxane (B2). Mass hydrophobization of the curable concrete mixture is achieved by way of adding at least one organosilicon compound (B) to the curable concrete mixture prior to its curing thereby reducing or avoiding an alkali-aggregate reaction in the cured concrete.

The invention relates to a method for reducing or avoiding the alkali-silica reaction in cured concrete by bulk hydrophobization of the concrete by addition of organosilicon compounds to the concrete composition before curing thereof.

Concrete consists of a mixture of cement, aggregate (gravel naturally washed or crushed, crushed stone and/or sand), water and concrete additives. In the following text, the word aggregate will be used as a synonym for gravel, crushed stone and/or sand.

The term alkali-silica reaction (=ASR) refers to a destructive reaction as can occur under unfavorable conditions in concrete constructions or in concrete components. It takes place especially when the concrete parts come into frequent contact with water and/or an aqueous salt solution. In this case, a gel arising from reaction with OH ions is formed at the interface and in the interior (pores) of the reactive aggregates (A) (e.g. gravel or sand grains) present in the concrete. When water additionally intrudes, the gel then swells and occupies a larger volume than the original volume at the unreacted surface or in the interior of the aggregate (A). This expansion usually leads to cracks and later to destruction of the concrete part. A particularly critical swelling behavior is displayed by aggregates (A) which have either a high alkali content or a high content of amorphous microstructure constituents.

The expansion caused by the ASR can be measured by means of a suitable test setup. If this exceeds a certain value, the concrete is referred to as an ASR-sensitive concrete. If such a concrete is used, for example, for the construction of roads or motorways, for traffic areas in airports, in tunnel construction and for pipes, tremendous damage caused by the alkali-silica reaction has to be expected within the next 10 to 20 years, and this may in an extreme case even make complete replacement of the traffic surface necessary. Concretes which, on the other hand, display no or only a comparatively small expansion in this test setup can be used in road construction.

In principle, the ASR can thus be avoided by choice of the correct unreactive aggregates (i.e. by choice of the correct gravel, sand, etc.) in the production of the concrete. However, a problem is that the aggregates necessary for concrete production are not available in the same quality everywhere. If they have a content of alkali metal ions and/or amorphous constituents of the structure which is too high, they count as reactive and there is a risk of the ASR.

In regions where the correct, sufficiently unreactive grades of sand and/or gravel are not available, they sometimes have to be transported from regions which may be several 100 km away. In view of the large amounts of sand and gravel used in concrete production, this need for transport represents a hitherto unsolved problem because of the associated energy consumption, environmental pollution and last but not least the related costs.

It was an object of the present invention to make possible the use of types of sand and/or gravel which otherwise could not be used in applications affected by the alkali-silica reaction, for example road and motorway construction.

The present invention provides a method for reducing or avoiding the alkali-silica reaction (=ASR) in cured concrete, in which a concrete mixture is produced and is processed and subsequently cured, characterized in that the concrete mixture contains

(A) alkali-sensitive aggregates and

(B) at least one organosilicon compound,
where (B) is selected from among
at least one silane (B1) of the formula (1)

RₐR¹Si(OR²)₃₋ₐ (1),
where
R is a monovalent, SiC-bonded hydrocarbon radical having from 1 to 3 carbon atoms,
R¹ is a monovalent, SiC-bonded hydrocarbon radical having from 4 to 22 carbon atoms,
the radicals R² can be identical or different and are each a hydrogen atom or a monovalent hydrocarbon radical and
a is 0 or 1,
and/or at least one siloxane (B2) containing units of the formula (2)

R³_{b}(R⁴O)_{c}R⁵_{d}SiO_{(4-b-c-d)/2} (2),
where
the radicals R³ can be identical or different and are each a monovalent, SiC-bonded, optionally substituted aliphatic hydrocarbon radical having from 1 to 3 carbon atoms or a divalent, optionally substituted, aliphatic hydrocarbon radical which has from 1 to 3 carbon atoms and bridges two units of the formula (2),
the radicals R⁴ can be identical or different and are each a hydrogen atom or a monovalent, optionally substituted hydrocarbon radical,
the radicals R⁵ can be identical or different and are each a monovalent, SiC-bonded, optionally substituted aromatic or aliphatic hydrocarbon radical having from 4 to 22 carbon atoms,
b is 0, 1, 2 or 3,
c is 0, 1, 2 or 3 and
d is 0 or 1,
with the proviso that the sum of b+c+d is less than or equal to 3 and the sum b+d in at least 40% of the units of the formula (2) is 0 or 1,

where this alkali sensitivity of the aggregate (A) is determined in accordance with the test method A set forth in the description (method using 3% strength NaCl solution) by means of the average swelling of three test specimens composed of the cured concrete mixture which are stored in a 3% strength NaCl solution,

and the average swelling of the three test specimens composed of a cured concrete mixture which contains alkali-sensitive aggregates (A) but no (B) (=reference specimen) is at least 0.1 mm/m after 168 days (steps A-1 to A-5 and repetition of the steps (B-1 to B4) ten times).

In a preferred embodiment of the method of the invention, the concrete contains an alkali-sensitive aggregate (A) which leads to a concrete which is so alkali-sensitive that the average swelling determined by test method A of the test specimens composed of a cured concrete mixture which contains alkali-sensitive aggregates (A) but no (B) (=reference specimen) is at least 0.2 mm/m after 168 days (steps A-1 to A-5 and repetition of the steps (B-1 to B4) ten times).

In a particularly preferred embodiment of the method of the invention, the concrete contains an alkali-sensitive aggregate (A) which leads to a concrete which is so alkali-sensitive that the average swelling determined by test method A of the test specimens composed of a cured concrete mixture which contains alkali-sensitive aggregates (A) but no (B) (=reference specimen) is at least 0.3 mm/m after 168 days (steps A-1 to A-5 and repetition of the steps (B-1 to B4) ten times).

The invention further provides a method for reducing or avoiding the alkali-silica reaction (=ASR) in cured concrete, in which a concrete mixture is produced and this is processed and subsequently cured, characterized in that the concrete mixture contains

(A) alkali-sensitive aggregates and

(B) at least one organosilicon compound,

where (B) is selected from among
at least one silane (B1) of the formula (1)

RₐR¹Si(OR²)₃₋ₐ (1),
where
R is a monovalent, SiC-bonded hydrocarbon radical having from 1 to 3 carbon atoms,
R¹ is a monovalent, SiC-bonded hydrocarbon radical having from 4 to 22 carbon atoms,
the radicals R² can be identical or different and are each a hydrogen atom or a monovalent hydrocarbon radical and
a is 0 or 1,
and/or contains at least one siloxane (B2) containing units of the formula (2)

R³_{b}(R⁴O)_{c}R⁵_{d}SiO_{(4-b-c-d)/2} (2),
where
the radicals R³ can be identical or different and are each a monovalent, SiC-bonded, optionally substituted aliphatic hydrocarbon radical having from 1 to 3 carbon atoms or a divalent, optionally substituted, aliphatic hydrocarbon radical which has from 1 to 3 carbon atoms and bridges two units of the formula (2),
the radicals R⁴ can be identical or different and are each a hydrogen atom or a monovalent, optionally substituted hydrocarbon radical,
the radicals R⁵ can be identical or different and are each a monovalent, SiC-bonded, optionally substituted aromatic or aliphatic hydrocarbon radical having from 4 to 22 carbon atoms,
b is 0, 1, 2 or 3,
c is 0, 1, 2 or 3 and
d is 0 or 1,
with the proviso that the sum of b+c+d is less than or equal to 3 and the sum b+d in at least 40% of the units of the formula (2) is 0 or 1,

where this alkali sensitivity of the aggregate (A) is determined in accordance with the test method B set forth in the description (method using 10% strength NaCl solution) by means of the average swelling of three test specimens composed of the cured concrete mixture which are stored in a 10% strength NaCl solution,

and the average swelling of the three test specimens composed of a cured concrete mixture which contains alkali-sensitive aggregates (A) but no (B) (=reference specimen)

is at least 0.2 mm/m after 168 days (steps A-1 to A-5 and repetition of the steps (B-1 to B4) ten times).

In a preferred embodiment of the method of the invention, the concrete contains an alkali-sensitive aggregate (A) which leads to a concrete which is so alkali-sensitive that the average swelling determined by test method B of the test specimens composed of a cured concrete mixture which contains alkali-sensitive aggregates (A) but no (B) (=reference specimen) is at least 0.3 mm/m after 168 days (steps A-1 to A-5 and repetition of the steps (B-1 to B4) ten times).

In a particularly preferred embodiment of the method of the invention, the concrete contains an alkali-sensitive aggregate (A) which leads to a concrete which is so alkali-sensitive that the average swelling determined by test method A of the test specimens composed of a cured concrete mixture which contains alkali-sensitive aggregates (A) but no (B) (=reference specimen) is at least 0.4 mm/m after 168 days (steps A-1 to A-5 and repetition of the steps (B-1 to B4) ten times).

Preference is given to using (B) as an aqueous preparation. Particular preference is given to using (B) as an aqueous preparation which contains at least one silane (B1) of the formula (1) and at least one siloxane (B2) of the formula (2).

In a preferred embodiment of the invention, component (B) is used in such an amount that the average swelling determined by the test method A of the test specimens composed of a cured concrete mixture which contains alkali-sensitive aggregates (A) and (B) is at least 20% lower, preferably at least 30% lower,

particularly preferably at least 40% lower, more preferably at least 50% lower and very particularly preferably at least 70% lower, than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

In a preferred embodiment of the invention, component (B) is used in such an amount that the average swelling determined by the test method B of the test specimens composed of a cured concrete mixture which contains alkali-sensitive aggregates (A) and (B) is at least 20% lower, preferably at least 30% lower, particularly preferably at least 40% lower, more preferably at least 50% lower and very particularly preferably at least 70% lower, than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

In a very preferred embodiment, component (B) is used in such an amount that both the average swelling determined by the test method A and the average swelling determined by the test method B of the test specimens composed of a cured concrete mixture which contains alkali-sensitive aggregates (A) and (B) are in each case at least 20% lower, preferably at least 30% lower, particularly preferably at least 40% lower, more preferably at least 50% lower and very particularly preferably at least 70% lower, than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

The invention is based on the surprising discovery that the organosilicon compound (B) according to the invention is able to reduce the extent and consequences of the ASR significantly. This makes it possible to use locally available types of gravel in, for example, road construction even when the use thereof leads to an insufficiently alkali-stable concrete. In this way, high transport costs for gravel from regions further away, sometimes even regions several 100 km away, can be avoided. Since transport of gravel over relatively long distances is also associated with a high energy consumption, the method of the invention is also able to make a significant contribution to reducing CO₂ emissions and thus to the environment.

Examples of radicals R are alkyl radicals such as the methyl, ethyl, n-propyl, isopropyl radicals and alkenyl radicals such as the vinyl, 1-propenyl and 2-propenyl radicals.

The radical R is preferably a methyl radical.

Examples of radicals R¹ are alkyl radicals such as hexyl radicals, e.g. the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; tetradecyl radicals such as the n-tetradecyl radical; hexadecyl radicals such as the n-hexadecyl radical; octadecyl radicals such as the n-octadecyl radical; cycloalkyl radicals such as cyclohexyl, cycloheptyl and methylcyclohexyl radicals.

Radicals R¹ are preferably alkyl radicals having from 6 to 16 carbon atoms, particularly preferably alkyl radicals having from 8 to 12 carbon atoms, in particular the n-octyl or isooctyl radical.

Radicals R² are preferably alkyl radicals having from 1 to 4 carbon atoms, particularly preferably the methyl, ethyl, n-propyl or isopropyl radical.

Examples of the silane (B1) are hexylsilanes such as n-hexyltrimethoxysilanes, n-hexyltriethoxysilanes, cyclohexyltrimethoxysilanes, cyclohexyltriethoxysilanes, n-hexylmethyldimethoxysilane or n-hexylmethyldiethoxysilane, octylsilanes such as n-octyltrimethoxysilane, n-octyltriethoxysilane, n-octyltributoxysilane, 2,2,4-trimethylpentyltrimethoxysilane, 2,2,4-trimethylpentyltriethoxysilane, n-decyltriethoxysilane, n-decyltrimethoxysilane, n-dodecyltriethoxysilane, n-dodecyltrimethoxysilane, n-tetradecyltrimethoxysilane, n-tetradecyltrimethoxysilane, n-hexadecyltrimethoxysilane, n-hexadecyltriethoxysilane, octadecyltrimethoxysilane and octadecyltriethoxysilane.

The silane (B1) is preferably n-octyltrimethoxysilane, n-octyltriethoxysilane, 2,2,4-trimethylpentyltrimethoxysilane, 2,2,4-trimethylpentyltriethoxysilane, hexadecyltrimethoxysilane, hexadecyltriethoxysilane, particularly preferably n-octyltrimethoxysilane, n-octyltriethoxysilane, 2,2,4-trimethylpentyltrimethoxysilane and 2,2,4-trimethylpentyltriethoxysilane.

Examples of radicals R⁵ are the vinyl radical, the allyl radical, alkyl radicals such as the 1-n-butyl, 2-n-butyl, isobutyl, t-butyl, n-pentyl, isopentyl, neopentyl, tert-pentyl radical, cyclopentyl; hexyl radicals such as the n-hexyl or cyclohexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; tetradecyl radicals such as the n-tetradecyl radical; hexadecyl radicals such as the n-hexadecyl radical; octadecyl radicals such as the n-octadecyl radical; amino group-containing radicals of the formulae H₂N(CH₂)₃—, H₂N(CH₂)₂NH(CH₂)₃— or H₂N(CH₂)₂NH(CH₂)₂NH(CH₂)₃—;

aryl radicals such as the phenyl, naphthyl, anthryl and phenanthryl radical; or alkaryl radicals such as o-, m-, p-tolyl radicals; xylyl radicals and ethylphenyl radicals; and aralkyl radicals such as the benzyl radical and the α- and β-phenylethyl radicals.

Radicals R⁵ are preferably alkyl radicals such as 1-n-butyl, 2-n-butyl, isobutyl, tert-butyl, n-pentyl, isopentyl, neopentyl, tert-pentyl radical, cyclopentyl; hexyl radicals such as the n-hexyl or cyclohexyl radical; heptyl radicals such as the n-heptyl radical; octyl radicals such as the n-octyl radical and iso-octyl radicals such as the 2,2,4-trimethylpentyl radical; nonyl radicals such as the n-nonyl radical; decyl radicals such as the n-decyl radical; dodecyl radicals such as the n-dodecyl radical; tetradecyl radicals such as the n-tetradecyl radical; hexadecyl radicals such as the n-hexadecyl radical or a phenyl radical.

The radical R⁵ is particularly preferably an n-octyl radical, a 2,2,4-trimethylpentyl radical; an n-hexadecyl radical or a phenyl radical.

Examples of radicals R⁴ are alkyl radicals such as the methyl, ethyl, n-propyl or isopropyl radical.

The radical R⁴ is preferably the methyl radical.

Radicals R³ are preferably alkyl radicals having from 1 to 3 carbon atoms, particularly preferably a methyl or ethyl radical.

Preference is given to using siloxanes (B2) which consist of units of the formula (2), the sum b+d being 0 or 1 in 40% of the units of the formula (2).

The siloxanes (B2) used according to the invention can be any previously known linear, cyclic or branched siloxanes.

The component (B2) particularly preferably comprises organopolysiloxane resins (B2a) which consist of repeating units of the formula (2), with the proviso that b+d has the value of 1 in at least 30% of all repeating units of the formula (2) and can also have the value of 1 in 100% of all repeating units of the formula (2).

It is likewise particularly preferred for b+d averaged over all repeating units of the formula (2) to have a value of from 0.9 to 1.6, with b=1 in combination with d=0, b=0 in combination with d=1 and b=2 in combination with d=0 being particularly preferred values for the repeating units of the formula (2).

It is likewise particularly preferred for c averaged over all repeating units of the general formula (2) to have an average value of from 0.1 to 1.8.

It is likewise particularly preferred for the unit —OR⁴ to be a hydroxy group in not more than 10 mol % of all units —OR⁴ averaged over all repeating units of the formula (2).

The organopolysiloxane resins (B2a) can be solid or liquid. The organopolysiloxane resins (B2a) are preferably liquid and have a viscosity of from 1000 to 400 000 mPas at 25° C. and the pressure of the ambient atmosphere, i.e. at from 900 to 1100 hPa. The weight-average molecular weight of these resins determined by gel permeation chromatography is preferably from 200 to 200 000 g/mol, in particular from 1000 to 20 000 g/mol.

The viscosity of liquids which are not paste-like is, for the purposes of the present invention, determined using a viscometer AVS from Schott (Ubbelohde viscometer; a detailed description of the viscosity measurement may be found in DIN 51562, part 1) after being brought to 25° C.

The number-average molar mass Mₙ is, for the purposes of the present invention, determined by means of size exclusion chromatography (SEC) against a polystyrene standard, in THF, at 60° C., flow rate 1.2 ml/min and detection using an RI (refractive index) detector on a column set Styragel HR3-HR4-HR5-HR5 from Waters Corp. USA using an injection volume of 100 μl.

In a further preferred embodiment of the invention, the component (B2) comprises polydimethylsiloxanes (B2b).

The polydimethylsiloxanes (B2b) can be branched or unbranched. They are preferably unbranched. The polydimethylsiloxanes (B2b) preferably have end groups of the formula —Si(CH₃)₃ or —Si(CH₃)₂OH.

The polydimethylsiloxanes (B2b) are liquid and have a viscosity of from 1000 to 1 000 000 mPas at 25° C. and the pressure of the ambient atmosphere, i.e. at from 900 to 1100 hPa. The weight-average molecular weight of these resins determined using gel permeation chromatography is preferably from 1000 to 2 000 000 g/mol, in particular from 2000 to 1 000 000 g/mol.

The compositions used according to the invention contain component (B2) in amounts of preferably from 5 to 400 parts by weight, particularly preferably from 20 to 2000 parts by weight, more preferably from 40 to 100 parts by weight, in each case based on 100 parts by weight of component (B1).

In a preferred embodiment of the invention, the component (B) is added in the form of an aqueous dispersion (DisB) to the concrete mixture. Such dispersions contain suitable emulsifiers (C), water (D) and optionally further additives (E) in addition to the component (B).

As emulsifiers (C), it is possible to use all emulsifiers which have hitherto also been used for the production of siloxane dispersions. As emulsifiers (E), it is possible to use anionic, nonionic, cationic and amphoteric surfactants or mixtures thereof. As an alternative, polymeric compounds which have emulsifying properties, e.g. polyvinyl alcohols, in particular polyvinyl alcohols having a degree of hydrolysis of 75-95%, can also be used.

The component (C) which is optionally used preferably comprises nonionic emulsifiers or mixtures of nonionogenic emulsifiers and ionic emulsifiers.

Examples of the nonionic emulsifiers (C) used according to the invention are sorbitan fatty acid esters, ethoxylated sorbitan fatty acid esters, ethoxylated fatty acids, ethoxylated linear or branched alcohols having from 10 to 20 carbon atoms, ethoxylated alkylphenols, pentaerythritol fatty acid esters, glycerol esters and alkylpolyglycosides.

The nonionic emulsifiers (C) are preferably sorbitan fatty acid esters, ethoxylated sorbitan fatty acid esters, ethoxylated fatty acids, ethoxylated linear or branched alcohols having from 10 to 20 carbon atoms or ethoxylated triglycerides.

The compositions used according to the invention preferably do not contain any ethoxylated alkylphenols since these are known not to be environmentally friendly.

When nonionic emulsifiers are used as component (C), they can be only one type of a nonionogenic emulsifier or be a mixture of a plurality of nonionogenic emulsifiers. Preference is given to at least one nonionic emulsifier (C) having an HLB of greater than or equal to 12, in particular greater than or equal to 14.

Mixtures of nonionogenic emulsifiers in which at least one emulsifier has an HLB of greater than or equal to 12 are preferably used as component (C). Here, the proportion of emulsifiers (C) having an HLB of greater than or equal to 12 in the emulsifier mixture (C) is preferably at least 30% by weight.

The HLB expresses the equilibrium between hydrophilic and hydrophobic groups of an emulsifier. The definition of the HLB and methods for determining it are generally known and are described, for example, in Journal of Colloid and Interface Science 298 (2006) 441-450 and the references cited therein.

As anionic emulsifiers (C), it is possible to use, for example, alkyl sulfonates, alkyl sulfates and alkyl phosphates.

Examples of cationic emulsifiers (C) are all known quaternary ammonium compounds which bear at least one substituted or unsubstituted hydrocarbon radical having at least 10 carbon atoms, e.g. dodecyldimethylammonium chloride, tetradecyltrimethylammonium bromide, stearyltrimethylammonium chloride, distearyldimethylammonium chloride, cetyltrimethylammonium chloride, behenyltrimethylammonium bromide, dodecylbenzyldimethylammonium chloride and benzyltrimethylammonium chloride.

When cationic emulsifiers are used as component (C), preference is given to aryltrimethylammonium or alkyltrimethylammonium salts such as stearyltrimethylammonium chloride or cetyltrimethylammonium chloride, particularly preferably benzyltrialkylammonium salts, in particular trimethylbenzylammonium chloride or trimethylbenzylammonium methosulfate.

Further examples are all known quaternary imidazolinium compounds which bear at least one substituted or unsubstituted hydrocarbon radical having at least 10 carbon atoms, e.g. 1-methyl-2-stearyl-3-stearylamidoethylimidazolinium methosulfate, 1-methyl-2-norstearyl-3-stearylamidoethylimidazolinium methosulfate, 1-methyl-2-oleyl-3-oleylamidoethylimidazolinum methosulfate, 1-methyl-2-stearyl-3-methylimidazolinum methosulfate, 1-methyl-2-behenyl-3-methylimidazolinum methosulfate and 1-methyl-2-dodecyl-3-methylimidazolinum methosulfate.

If component (C) is used for producing the dispersions (DisB), the amounts used are preferably from 0.1 to 15 parts by weight, particularly preferably from 0.3 to 8 parts by weight, in each case based on 100 parts by weight of component (B). The dispersions (DisB) preferably contain emulsifiers (C).

The water used as component (D) can be any type of water, for instance natural water such as rainwater, ground water, spring water, river water and seawater, chemical water such as deionized water, distilled or (multiply) redistilled water, mains water or mineral water.

The dispersions (DisB) contain water (D) in amounts of preferably from 10 to 90% by weight, particularly preferably from 20 to 80% by weight, in each case based on the total amount of the composition. Particular preference is given in the method of the invention to highly diluted compositions having a content of water (D) of from 30 to 70% by weight.

Furthermore, the dispersion (DisB) added to the concrete can contain further additives (E). These can be all additives which have hitherto also been used in aqueous dispersions, e.g. biocides and/or other preservatives, organosilicon compounds different from (B1) and (B2), thickeners, substances for adjusting the pH, fragrances, dyes, pigments such as iron oxide, alcohols and/or antifreezes such as glycols and glycol ethers.

Examples of thickeners (E) which may optionally be used are polyacrylic acid, polyacrylates, cellulose ethers such as carboxymethyl cellulose and hydroxyethyl cellulose, natural gums such as xanthan gum and polyurethanes.

Examples of organosilicon compounds (E) which may optionally be used are tetraethoxysilane, trimethylmethoxysilane, aminopropyltriethoxysilane and aminopropylmethyldimethoxysilane.

Examples of substances for adjusting the pH (E) which may optionally be used are aminosilanes and also amines such as monoethanolamine or alkali metal hydroxides. If it is necessary in order to ensure constancy of the pH over a prolonged period of time, it is also possible to use buffer systems such as salts of acetic acid, salts of phosphoric acid, salts of citric acid, in each case in combination with the free acid, depending on the desired pH.

In a preferred embodiment, the dispersion (DisB) added to the concrete contains ethanol and/or methanol as component (E) in amounts of preferably from 0.00001 to 1% by weight, particularly preferably from 0.0001 to 0.5% by weight. The amounts of alcohol mentioned are usually formed in the production of the composition used according to the invention and/or during storage of the composition.

The dispersions (DisB) are preferably dispersions containing

(B1) silanes of the formula (1) and/or

(B2) silicone resins composed of units of the formula (2)

(C) emulsifier

(D) water and

optionally (E) further additives.

The dispersions (DisB) preferably do not contain any components apart from the components (A) to (F) and the reaction products thereof.

The abovementioned components used according to the invention can in each case be one type of such a component or a mixture of at least two types of a respective component.

The dispersions (DisB) are preferably emulsions or suspensions, particularly preferably emulsions.

The production of the dispersions (DisB) can be carried out by methods known per se. They are usually produced by simple stirring together of all constituents in any order at temperatures of preferably from 1 to 50° C. and optionally subsequent homogenization.

The dispersions (DisB) have a solids content, i.e. a proportion of nonvolatile compounds (e.g.

determined in accordance with ASTM D 5095), of preferably from 0.01 to 90% by weight, particularly preferably from 20 to 80% by weight, more preferably from 30 to 70% by weight.

The dispersions (DisB) have a viscosity of preferably from 0.5 to 10 000 mm²/s, in particular from 1 to 1000 mm²/s, in each case measured at 25° C. by the abovementioned test method (viscosity of liquids which are not paste-like).

A typical concrete formulation contains, per cubic meter, 400 kg of cement, thus 0-70% by volume of gravel or crushed stone having a particle diameter of 2-22 mm, preferably 2-16 mm, and 30-100% by volume of sand (in the case of 100% sand, the formulation is referred to as mortar). The ratio of water to cement is typically 0.45. The water-cement value can be in the range from 0.3 to 0.7. If the sand and gravel or crushed stone contain amorphous constituents of the microstructure, these are reactive, i.e., alkali-sensitive, aggregates (A).

Examples of alkali-sensitive gravels (A) would be rhyolite or graywacke. Further reactive aggregates come from the following groups of minerals: argillite, dacite, porphyry, tuff, slate, siltstone, opal, obsidian, cristobalite, tridymite, chalcedony, andesite, phyllite, slate, gneisses, gneiss granite, sandstone, latites, synthetic glass, volcanic glass, flint, cryptocrystalline and stressed or metamorphic quartz, chert, some dolomitic limestones or granite.

The component (B) is added in a proportion of 0.01-0.5% by weight, preferably 0.1-0.3% by weight, based on the solids content of the emulsion and based on cement of the concrete. The point in time of addition can be before or after the addition of water.

Test Method A (Method Using 3% Strength Aqueous NaCl Solution)

3 concrete prisms having the dimensions 75 mm×75 mm×280 mm are produced as test specimens and stored as shown in table 1. The swelling corresponds to the average value in [mm/m] from the measurement of the swelling of the 280 mm edge of the 3 test specimens after the 10th cycle=a total of 168 days, i.e. after steps A-1 to A-5 and repetition of the steps B-1 to B4 ten times.

If the swelling is to be followed continuously, the measurement is carried out after each cycle. If long-term studies are desired, it is possible to increase the number of cycles.

TABLE 1

| | Step | | | |
|---|---|---|---|---|
| Phase | No. | Duration | | Storage conditions |
| Preliminary storage | A-1 | 1 | day | 20 ± 2° C. and covered in |
| | | | | the mold |
| | A-2 | 6 | days | 20 ± 2° C. and ≥95% RH |
| | A-3 | 14 | days | 20 ± 2° C. and 65 ± 5% RH |
| | A-4 | 6 | days | 60 ± 2° C. and ≥98% RH |
| | A-5 | 1 | day | 20 ± 2° C. and ≥98% RH |
| Cyclic treatment at | B-1 | 5 | days | 60 ± 2° C. in a drying oven |
| 60° C. with an | B-2 | 2 | days | 20 ± 2° C. in an alkaline |
| alkaline solution | | | | solution (3% strength NaCl |
| (repetition until the | | | | solution) |
| desired age of the | B-3 | 6 | days | 60 ± 2° C. and ≥98% RH |
| concrete has been | B-4 | 1 | day | 20 ± 2° C. and ≥98% RH |
| attained) | | | | |

where RH = atmospheric humidity

Test Method B (Method Using 10% Strength Aqueous NaCl Solution)

3 concrete prisms having the dimensions 75 mm×75 mm×280 mm are produced as test specimens and stored as shown in table 2. The swelling corresponds to the average value in [mm/m] from the measurement of the swelling of the 280 mm edge of the 3 test specimens after the 10th cycle=a total of 168 days, i.e. after steps A-1 to A-5 and repetition of the steps B-1 to B4 ten times.

If the swelling is to be followed continuously, the measurement is carried out after each cycle. If long-term studies are desired, it is possible to increase the number of cycles.

TABLE 2

| | Step | | | |
|---|---|---|---|---|
| Phase | No. | Duration | | Storage conditions |
| Preliminary storage | A-1 | 1 | day | 20 ± 2° C. and covered |
| | | | | in the mold |
| | A-2 | 6 | days | 20 ± 2° C. and ≥95% RH |
| | A-3 | 14 | days | 20 ± 2° C. and 65 ± 5% RH |
| | A-4 | 6 | days | 60 ± 2° C. and ≥98% RH |
| | A-5 | 1 | day | 20 ± 2° C. and ≥98% RH |
| Cyclic treatment | B-1 | 5 | days | 60 ± 2° C. in a drying oven |
| at 60° C. with | B-2 | 2 | days | 20 ± 2° C. in an alkaline |
| an alkaline solution | | | | solution (10% strength |
| (repetition until | | | | NaCl solution) |
| the desired age | B-3 | 6 | days | 60 ± 2° C. and ≥98% RH |
| of the concrete | B-4 | 1 | day | 20 ± 2° C. and ≥98% RH |
| has been attained) | | | | |

where RH = atmospheric humidity

The invention has the advantage that reactive aggregates, e.g. the abovementioned reactive aggregates, and also reactive types of sand which are available locally at low cost can also be used in the concrete or render while nevertheless giving an ASR-stable concrete or render.

A further advantage of the invention is the simple and inexpensive addition of the additives to the concrete and mortar formulation.

Further advantages of the invention are that its use generally leads to an increase in the life of buildings, traffic areas in airports, tunnel constructions, pipes, roads, bridges and construction works which could otherwise have a shorter life due to a possible ASR.

The following examples describe the in-principle performance of the present invention, but without restricting the invention to the contents disclosed therein.

In the following examples, all parts and percentages specified are, unless indicated otherwise, by weight. Unless indicated otherwise, the following examples are carried out at a pressure of the ambient atmosphere, i.e. at about 1000 hPa, and at room temperature, i.e. about 20° C., or a temperature which is established on combining the reactants at room temperature without additional heating or cooling.

### EXAMPLES

### Production Example 1: Production of a Dispersion Containing Silane (B1) and Siloxane (B2)

38.4 g of water, 38.4 g of emulsifier (POE(16)isotridecyl ether, obtainable under the name Arlypon® IT 16 from BASF AG, D-Ludwigshafen), are placed in a 2 liter beaker and mixed with 4.3 g of N-(2-aminoethyl)-3-aminopropyltrimethoxysilane (obtainable under the name Geniosil® GF 91 from Wacker Chemie AG, D-Burghausen) by means of a rotor-stator homogenizer (Ultra-Turrax T50, IKA-Werke GmbH 6 Co.KG, D-Staufen) for 0.5 min at 4000 rpm. 100 g of 2,2,4-trimethylpentyltriethoxysilane (obtainable under the name SILRES® BS 1701 from Wacker Chemie AG, D-Burghausen) are subsequently added and the mixture is mixed for 2 min at 4000 rpm, forming a gel-like paste.

While continuing to mix at 4000 rpm, 10 g of water and 122.4 g of an organopolysiloxane of the formula (CH₃)_{0.7}(2,2,4-trimethylpentyl)_{0.3}Si(OCH₃)_{1.3}O_{0.85} having an average molecular weight of about 800 g/mol and a viscosity of about 17 mm²/s are subsequently added alternately within 2 minutes, with the paste-like consistency of the mixture being maintained. Finally, while continuing to mix at 4000 rpm, 25 g of water and 389.6 g of 2,2,4-trimethylpentyltriethoxysilane are added alternately within 3 minutes, with the paste-like consistency of the mixture likewise being maintained. The mixture is subsequently stirred for a further 5 minutes at 4000 rpm.

While continuing to mix at 4000 rpm, 467.8 g of water are then added alternately within 5 minutes, forming a liquid emulsion. Finally, 1.1 g of 99% strength acetic acid, 2.64 g of a first preservative (“Acticide MV”, obtainable from Thor GmbH, D-Speyer) and 0.36 g of a second preservative (MIT 10, likewise obtainable from Thor GmbH, D-Speyer) are added and stirred in for 0.5 min at 4000 rpm.

Building Materials and Test Methods

Concrete Compositions and Test Specimens

The concrete compositions are shown in table 3 and table 4. The formulations of comparative example 1 (C-Ex. 1) and examples 1a & 1b (Ex. 1a & Ex. 1b) are identical with the exception of the addition of the respective hydrophobizing agent. The same applies to the concretes of comparative example 2 (C-Ex. 2) and examples 2a & 2b (Ex. 2a & Ex. 2b). With the exception of the air pore former which was not used in the model experiments, all formulations correspond to the standard composition “Oberbeton (0/8)” which according to the general circular Straßenbau No. 04/2013 is to be used for the WS basic testing of coarse rock particle size fractions.

TABLE 3
concrete compositions for comparative
example 1 and examples 1a & 1b

| Raw material | Unit | C-Ex. 1 | Ex. 1a | Ex. 1b |
|---|---|---|---|---|
| Cement CEM I 42.5N | [kg/m³] | 430 | 430 | 430 |
| Water | [kg/m³] | 193.5 | 193.5 | 193.5 |
| Sand (0/2 mm) | [kg/m³] | 525 | 525 | 525 |
| Crushed graywacke (5/8 mm) | [kg/m³] | 1253 | 1253 | 1253 |
| Water-cement value | [—] | 0.45 | 0.45 | 0.45 |
| 2,2,4-Trimethylpentyl- | [% by | — | 0.2 | — |
| triethoxysilane | weight of | | | |
| | the cement] | | | |
| Emulsion corresponding to | [% by | — | — | 0.5 |
| production example 1 | weight of | | | |
| | the cement] | | | |

TABLE 4
concrete compositions for comparative
example 2 and examples 2a & 2b

| Raw material | Unit | C-Ex. 2 | Ex. 2a | Ex. 2b |
|---|---|---|---|---|
| Cement CEM I 42.5N | [kg/m³] | 430 | 430 | 430 |
| Water | [kg/m³] | 193.5 | 193.5 | 193.5 |
| Sand (0/2 mm) | [kg/m³] | 525 | 525 | 525 |
| Crushed rhyolite (5/8 mm) | [kg/m³] | 1211 | 1211 | 1211 |
| Water-cement value | [—] | 0.45 | 0.45 | 0.45 |
| 2,2,4-Trimethylpentyl- | [% by | — | 0.2 | — |
| triethoxysilane | weight of | | | |
| | the cement] | | | |
| Emulsion corresponding to | [% by | — | — | 0.5 |
| production example 1 | weight of | | | |
| | the cement] | | | |

The production of the concretes was carried out by the following mixing method:

1. mixing of the dry components (about 10 seconds)

2. addition of water

3. addition of the additives (only examples 1a, 1b, 2a & 2b)

4. mixing for two minutes

The following test specimens were produced in steel molds from each concrete and compacted on a shaking table:

Six prisms (75 mm×75 mm×280 mm) for the 60° C. concrete tests according to test methods A and B with introduction of alkali from the outside.

Three test specimens having an edge length of 150 mm for testing of the compressive strength and the apparent density.

After production, the test specimens were left in the mold, covered with a moist cloth and stored at 20±2° C. for 24±1 hours. After removal of the mold, the test specimens were stored for a further time in accordance with the intended test method.

Test Methods

Fresh Concrete Testing

The fresh concrete apparent density in accordance with DIN EN 12350-6 was determined about 10 minutes after mixing.

The degree of compaction in accordance with DIN EN 12350-4 and the slump flow in accordance with DIN EN 12350-5 were determined about 30 minutes after mixing.

Set Concrete Testing

The testing of the compressive strength of the concrete compositions in accordance with DIN EN 12390-3 was carried out after 28 days on three test specimens having an edge length of 150 mm. The set concrete apparent density was determined in accordance with DIN EN 12390-7. The test specimens were stored in accordance with the national appendix to DIN EN 12390-2 (7 days under water, then in a controlled atmosphere chamber at 20±2° C. and 65±5% RH).

60° C. Concrete Test with Supply of Alkali from the Outside (ASR Performance Test)

The resistance of the three concretes to the alkali-silica reaction was examined by means of test method A or test method B with a 60° C. concrete test with supply of alkali from the outside.

3 concrete test specimens in each case (prisms having the dimensions 75 mm×75 mm×280 mm) were stored as shown in table 5 in accordance with test method A or test method B. According to test method A, the test specimens are stored in a 3% strength aqueous NaCl solution in step B-2, while in the case of test method B a 10% strength NaCl solution is used here.

The expansion of the test specimens was measured after 28 days (step A-5) and also after each test cycle (step B-4). The exposure as per step B-1 to B-4 was repeated 14 times for each concrete.

A concrete suitable for road construction has to have an expansion of less than 0.3 mm/m according to test method A after 10 repetitions of the steps B-1 to B-4 (10 test cycles). In the case of test method B, the expansion must be not more than 0.5 mm/m.

TABLE 5
Storage conditions during the 60° C. concrete
test with supply of alkali from the outside

| | Step | | | |
|---|---|---|---|---|
| Phase | No. | Duration | | Storage conditions |
| Preliminary storage | A-1 | 1 | day | 20 ± 2° C. and covered in the |
| | | | | mold |
| | A-2 | 6 | days | 20 ± 2° C. and ≥95% RH |
| | A-3 | 14 | days | 20 ± 2° C. and 65 ± 5% RH |
| | A-4 | 6 | days | 60 ± 2° C. and ≥98% RH |
| | A-5 | 1 | day | 20 ± 2° C. and ≥98% RH |
| Cyclic treatment at | B-1 | 5 | days | 60 ± 2° C. in a drying oven |
| 60° C. with an | B-2 | 2 | days | 20 ± 2° C. in an alkaline |
| alkaline solution | | | | solution |
| (repetition until the | | | | Test method A: 3% strength |
| desired concrete age | | | | NaCl solution |
| has been attained) | | | | Test method B: 10% strength |
| | | | | NaCl solution |
| | B-3 | 6 | days | 60 ± 2° C. and ≥98% RH |
| | B-4 | 1 | day | 20 ± 2° C. and ≥98% RH |

Fresh Concrete Properties

The properties of the fresh concretes are shown in table 6.

TABLE 6
fresh concrete properties

| | | Degree of | |
|---|---|---|---|
| | Density in | compaction in | Slump flow in |
| | accordance with | accordance with | accordance with |
| Concrete | DIN EN 12350-6 | DIN EN 12350-4 | DIN EN 12350-5 |
| C-Ex. 1 | 2410 kg/m³ | 1.33 | — |
| Ex. 1a | 2400 kg/m³ | 1.33 | — |
| Ex. 1b | 2390 kg/m³ | 1.33 | — |
| C-Ex. 2 | 2360 kg/m³ | — | 41 cm |
| Ex. 2a | 2350 kg/m³ | — | 39 cm |
| Ex. 2b | 2350 kg/m³ | — | 39 cm |

Set Concrete Properties

The compressive strength fc and the apparent density D of the concretes are shown in table 7.

TABLE 7
compressive strength and density of the concretes

| | Compressive strength | | | | Apparent density | | | |
|---|---|---|---|---|---|---|---|---|
| | fc in accordance with | | | | D in accordance with | | | |
| | DIN EN 12390-3 | | | | DIN EN 12390-7 | | | |
| Concrete | W 1 | W 2 | W 3 | Av. | W 1 | W 2 | W 3 | Av. |
| C-Ex. 1 | 70.1 | 67.3 | 70.2 | 69.2 | 2370 | 2370 | 2370 | 2370 |
| Ex. 1a | 62.7 | 63.5 | 62.1 | 62.8 | 2360 | 2360 | 2370 | 2360 |
| Ex. 1b | 62.7 | 60.4 | 61.9 | 61.7 | 2360 | 2350 | 2360 | 2360 |
| C-Ex. 2 | 73.3 | 72.1 | 72.7 | 72.7 | 2330 | 2320 | 2330 | 2330 |
| Ex. 2a | 63.0 | 63.6 | 64.5 | 63.7 | 2320 | 2320 | 2330 | 2320 |
| Ex. 2b | 63.4 | 63.6 | 63.5 | 63.5 | 2320 | 2320 | 2320 | 2320 |

Av. = average;
W = test specimen

60° C. Concrete Tests with Supply of Alkali from the Outside

Concretes Containing Crushed Graywacke (Comparative Example 1, Examples 1a & 1b)

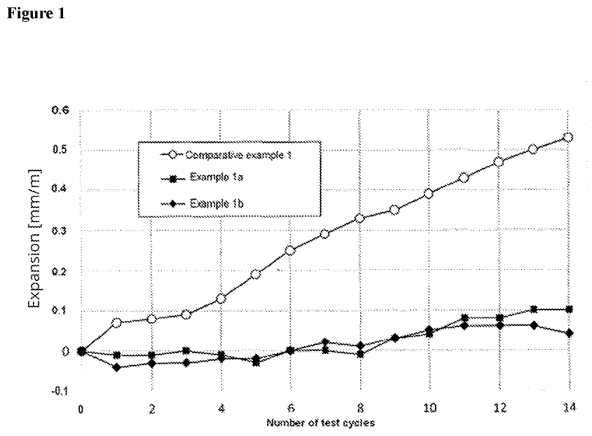

The average expansions of the concrete test specimens of comparative example 1 and of examples 1a & 1b during the 60° C. concrete test according to test method A, i.e. with supply of alkali from the outside by means of a 3% strength NaCl solution, are shown in FIG. 1. In the case of the concrete from comparative example 1, a continuous increase in the expansion up to an average value of 0.53 mm/m was observed after 14 test cycles. After 10 cycles, the expansion was 0.39 mm/m. The concretes from examples 1a & 1b had significantly lower expansion values up to a maximum of ≤0.10 mm/m (0.04 and 0.05 mm/m, respectively, after 10 cycles).

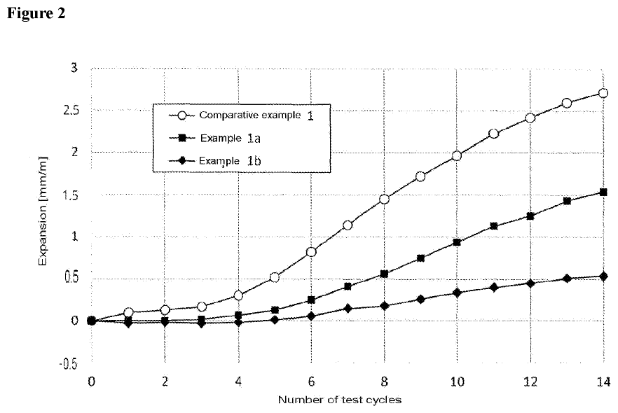

The average expansions of the concrete test specimens of comparative example 1 and examples 1a & 1b during the 60° C. concrete test according to test method B, i.e. with supply of alkali from the outside by means of a 10% strength NaCl solution, are shown in FIG. 2. The concrete from comparative example 1 had the highest expansion values after 14 test cycles and attained an average value of 2.72 mm/m. After 10 cycles, the expansion was 1.97 mm/m. In the case of the concrete from example 1a, an expansion value of 0.94 mm/m was determined after 10 test cycles and a value of 1.53 mm/m was determined after 14 cycles. In the case of the concrete from example lb, the value after 10 cycles was 0.34 mm/m and after 14 cycles was 0.54 mm/m.

Concretes Containing Crushed Rhyolite (Comparative Example 2, Examples 2a & 2b)

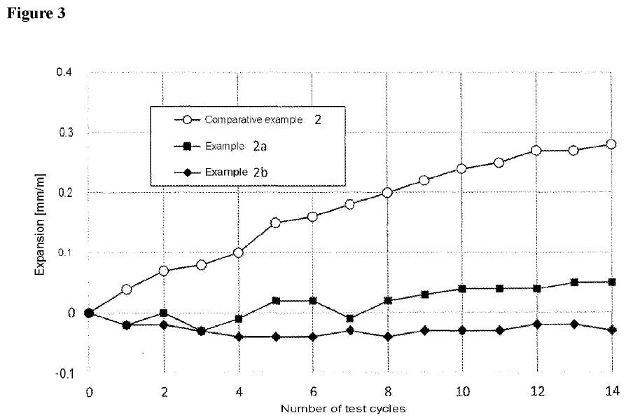

The average expansions of the concrete test specimens of comparative example 2 and of examples 2a & 2b during the 60° C. concrete test according to test method A, i.e. with supply of alkali from the outside by means of a 3% strength NaCl solution, are shown in FIG. 3. In the case of the concrete from comparative example 2, a continuous increase in the expansion values to 0.24 mm/m after 10 test cycles and 0.28 mm/m after 14 cycles was found. The expansion values of the concretes from examples 2a & 2b remain close to zero for the entire duration of the test.

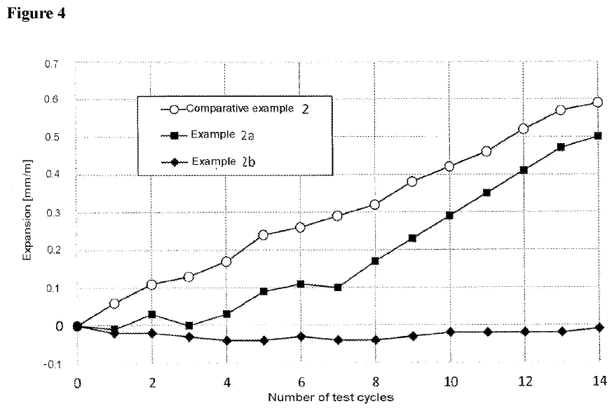

The average expansions of the concrete test specimens of comparative example 2 and of examples 2a & 2b during the 60° C. concrete test according to test method B, i.e. with supply of alkali from the outside by means of a 10% strength NaCl solution, are shown in FIG. 4. In the case of the concrete of comparative example 2, a continuous, virtually linear increase in the expansion over the entire course of the test was found and after 10 test cycles it attained a value of 0.42 mm/m and after 14 cycles a maximum of 0.59 mm/m. The expansion increase for the concrete of example 2a over the course of the first 6 test cycles was significantly lower than for the concrete of comparative example 2. However, a higher expansion increase was then observed, so that an expansion value of 0.29 mm/m was attained after 10 test cycles and a value of 0.52 mm/m was attained after 14 cycles. The expansion of the concrete of example 2b remained close to zero during the course of the entire 14 test cycles.

1-15. (canceled)

16. A method for reducing or avoiding an alkali-silica reaction in cured concrete, comprising:
providing a curable concrete mixture, wherein the curable concrete mixture comprises alkali-sensitive aggregates (A), at least one organosilicon compound (B) and/or at least one siloxane (B2);
wherein the at least one organosilicon compound (B) is selected from among at least one silane (B1) having a formula (1)
RₐR¹Si(OR²)₃₋ₐ (1);
wherein R is a monovalent SiC-bonded hydrocarbon radical having from 1 to 3 carbon atoms;
wherein R¹ is a monovalent SiC-bonded hydrocarbon radical having from 4 to 22 carbon atoms;
wherein radicals R² can be identical or different and are each a hydrogen atom or a monovalent hydrocarbon radical; and
wherein a is 0 or 1,
wherein the at least one siloxane (B2) comprises units having the formula (2)
R³_{b}R⁴_{c}(OR⁵)_{d}SiO_{(4-b-c-d)/2} (2);
where radicals R³ can be identical or different and are each a monovalent, SiC-bonded, optionally substituted aliphatic hydrocarbon radical having from 1 to 3 carbon atoms or a divalent, optionally substituted, aliphatic hydrocarbon radical which has from 1 to 3 carbon atoms and bridges two units of the formula (2);
wherein radicals R⁴ can be identical or different and are each a hydrogen atom or a monovalent, optionally substituted hydrocarbon radical;
wherein radicals R⁵ can be identical or different and are each a monovalent, SiC-bonded, optionally substituted aromatic or aliphatic hydrocarbon radical having from 4 to 22 carbon atoms;
wherein b is 0, 1, 2 or 3;
wherein c is 0, 1, 2 or 3;
wherein d is 0 or 1;
wherein the sum of b+c+d is less than or equal to 3 and the sum b+d in at least 40% of the units of the formula (2) is 0 or 1;
wherein at least one organosilicon compound (B) is an aqueous preparation which comprises at least one silane (B1) of the formula (1) and at least one siloxane (B2) of the formula (2);
wherein the alkali sensitivity of the alkali-sensitive aggregates (A) is determined in accordance with the test method A set forth in the description (method using 3% strength NaCl solution) by means of the average swelling of three test specimens composed of the cured concrete mixture which are stored in a 3% strength NaCl solution; and
wherein the average swelling of the three test specimens composed of a cured concrete mixture which contains alkali-sensitive aggregates (A) but no (B) (=reference specimen) is at least 0.1 mm/m after 168 days (steps A-1 to A-5 and repetition of the steps (B-1 to B4) ten times).

17. The method of claim 16, wherein the average swelling of the test specimens of a cured concrete mixture which contains alkali-sensitive aggregates (A) but no (B) (=reference specimen) is at least 0.2 mm/m after 168 days (steps A-1 to A-5 and repetition of the steps (B-1 to B4) ten times).

18. The method of claim 16, wherein the average swelling of the test specimens of a cured concrete mixture which contains alkali-sensitive aggregates (A) but no (B) (=reference specimen) is at least 0.3 mm/m after 168 days (steps A-1 to A-5 and repetition of the steps (B-1 to B4) ten times).

19. The method of claim 16, wherein the at least one organosilicon compound (B) is used in such an amount that the average swelling determined by the test method A of the test specimens composed of a cured concrete mixture which contains alkali-sensitive aggregates (A) and (B) is at least 20% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

20. The method of claim 16, wherein the at least one organosilicon compound (B) is used in such an amount that the average swelling determined by the test method A of the test specimens composed of a cured concrete mixture which contains alkali-sensitive aggregates (A) and (B) is at least 30% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

21. The method of claim 16, wherein the at least one organosilicon compound (B) is used in such an amount that the average swelling determined by the test method A of the test specimens composed of a cured concrete mixture which contains alkali-sensitive aggregates (A) and (B) is at least 40% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

22. The method of claim 16, wherein the at least one organosilicon compound (B) is used in such an amount that the average swelling determined by the test method B of the test specimens composed of a cured concrete mixture which contains alkali-sensitive aggregates (A) and (B) is at least 20% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

23. The method of claim 16, wherein the at least one organosilicon compound (B) is used in such an amount that the average swelling determined by the test method B of the test specimens composed of a cured concrete mixture which contains alkali-sensitive aggregates (A) and (B) is at least 30% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

24. The method of claim 16, wherein the at least one organosilicon compound (B) is used in such an amount that the average swelling determined by the test method B of the test specimens composed of a cured concrete mixture which contains alkali-sensitive aggregates (A) and (B) is at least 40% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

25. The method of claim 16, wherein the at least one organosilicon compound (B) is used in such an amount that both the average swelling determined by the test method A and the average swelling determined by the test method B of the test specimens composed of a cured concrete mixture which contains alkali-sensitive aggregates (A) and (B) are at least 20% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

26. The method of claim 16, wherein the at least one organosilicon compound (B) is used in such an amount that both the average swelling determined by the test method A and the average swelling determined by the test method B of the test specimens composed of a cured concrete mixture which contains alkali-sensitive aggregates (A) and (B) are at least 30% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

27. A method for reducing or avoiding an alkali-silica reaction in cured concrete, comprising:
providing a curable concrete mixture, wherein the curable concrete mixture comprises alkali-sensitive aggregates (A), at least one organosilicon compound (B) and/or at least one siloxane (B2);
wherein the at least one organosilicon compound (B) is selected from among at least one silane (B1) having a formula (1)
RₐR¹ Si(OR²)₃₋ₐ (1),
wherein R is a monovalent, SiC-bonded hydrocarbon radical having from 1 to 3 carbon atoms;
wherein R¹ is a monovalent, SiC-bonded hydrocarbon radical having from 4 to 22 carbon atoms;
wherein radicals R² can be identical or different and are each a hydrogen atom or a monovalent hydrocarbon radical; and
wherein a is 0 or 1;
wherein the at least one siloxane (B2) comprises units having the formula (2)
R³_{b}(R⁴O)_{c}R⁵_{d}SiO_{(4-b-c-d)/2} (2),
wherein the radicals R³ can be identical or different and are each a monovalent, SiC-bonded, optionally substituted aliphatic hydrocarbon radical having from 1 to 3 carbon atoms or a divalent, optionally substituted, aliphatic hydrocarbon radical which has from 1 to 3 carbon atoms and bridges two units of the formula (2);
wherein the radicals R⁴ can be identical or different and are each a hydrogen atom or a monovalent, optionally substituted hydrocarbon radical;
wherein the radicals R⁵ can be identical or different and are each a monovalent, SiC-bonded, optionally substituted aromatic or aliphatic hydrocarbon radical having from 4 to 22 carbon atoms;
wherein b is 0, 1, 2 or 3;
wherein c is 0, 1, 2 or 3;
wherein d is 0 or 1;
wherein the sum of b+c+d is less than or equal to 3 and the sum b+d in at least 40% of the units of the formula (2) is 0 or 1;
wherein the at least one organosilicon compound (B) is an aqueous preparation which contains at least one silane (B1) of the formula (1) and at least one siloxane (B2) of the formula (2);
where this alkali sensitivity of the aggregate (A) is determined in accordance with the test method B set forth in the description (method using 10% strength NaCl solution) by means of the average swelling of three test specimens composed of the cured concrete mixture which are stored in a 10% strength NaCl solution; and
wherein the average swelling of the three test specimens composed of a cured concrete mixture which contains alkali-sensitive aggregates (A) but no (B) (=reference specimen) is at least 0.2 mm/m after 168 days (steps A-1 to A-5 and repetition of the steps (B-1 to B4) ten times).

28. The method of claim 27, wherein the average swelling of the test specimens of a cured concrete mixture which contains alkali-sensitive aggregates (A) but no (B) (=reference specimen) is at least 0.3 mm/m after 168 days (steps A-1 to A-5 and repetition of the steps (B-1 to B4) ten times).

29. The method of claim 27, wherein the average swelling of the test specimens of a cured concrete mixture which contains alkali-sensitive aggregates (A) but no (B) (=reference specimen) is at least 0.4 mm/m after 168 days (steps A-1 to A-5 and repetition of the steps (B-1 to B4) ten times).

30. The method of claim 27, wherein the at least one organosilicon compound (B) is used in such an amount that the average swelling determined by the test method A of the test specimens composed of a cured concrete mixture which contains alkali-sensitive aggregates (A) and (B) is at least 20% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

31. The method of claim 27, wherein the at least one organosilicon compound (B) is used in such an amount that the average swelling determined by the test method A of the test specimens composed of a cured concrete mixture which contains alkali-sensitive aggregates (A) and (B) is at least 30% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

32. The method of claim 27, wherein the at least one organosilicon compound (B) is used in such an amount that the average swelling determined by the test method A of the test specimens composed of a cured concrete mixture which contains alkali-sensitive aggregates (A) and (B) is at least 40% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

33. The method of claim 27, wherein the at least one organosilicon compound (B) is used in such an amount that the average swelling determined by the test method B of the test specimens composed of a cured concrete mixture which contains alkali-sensitive aggregates (A) and (B) is at least 20% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

34. The method of claim 27, wherein the at least one organosilicon compound (B) is used in such an amount that the average swelling determined by the test method B of the test specimens composed of a cured concrete mixture which contains alkali-sensitive aggregates (A) and (B) is at least 30% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

35. The method of claim 27, wherein the at least one organosilicon compound (B) is used in such an amount that the average swelling determined by the test method B of the test specimens composed of a cured concrete mixture which contains alkali-sensitive aggregates (A) and (B) is at least 40% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

36. The method of claim 27, wherein the at least one organosilicon compound (B) is used in such an amount that both the average swelling determined by the test method A and the average swelling determined by the test method B of the test specimens composed of a cured concrete mixture which contains alkali-sensitive aggregates (A) and (B) are at least 20% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).

37. The method of claim 27, wherein the at least one organosilicon compound (B) is used in such an amount that both the average swelling determined by the test method A and the average swelling determined by the test method B of the test specimens composed of a cured concrete mixture which contains alkali-sensitive aggregates (A) and (B) are at least 30% lower than the average swelling of a cured concrete mixture which contains alkali-sensitive aggregates (A) but no (B) (=reference specimen) after a storage time of 168 days (steps A-1 to A-5 and repetition of the steps (B-1 to B4) ten times).
